(19) United States
(12) Patent Application Publication
(10) Pub. No.: US 2006/0024651 A1
(43) Pub. Date: Feb. 2, 2006

(54) Sneeks

(76) Inventor: Antonio M. Davis, Lynchburg, VA (US)

Correspondence Address: Antonio M. Davis, Sr., 2045 Miller Drive, Lynchburg, VA, 24501, US

(21) Appl. No.: 10/909,785

(22) Filed: Aug. 2, 2004

(51) Int. Cl. G09B 19/24

(52) U.S. Cl. 434/260

(57) ABSTRACT

An educational device for teaching, training, and aiding a child or mentally-challenged person to lace shoes and tie a shoelace bow is of simple construction and provides easy guidance. The shoe device is composed of a symmetrical flat base approximating the shape of a shoe with two flat panels containing equally spaced holes attached oppositely on the outer edge of the flat base so as to resemble a pair of opposing flaps. Each component is colored using differing primary and secondary colors to focus attention and aid in separating regions of the device for ease of instruction.

### CROSS REFERENCE TO RELATED APPLICATION

See prior Disclosure Document (No. 526960, Feb. 26, 2003) relating to this invention.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM

### LISTING COMPACT DISK APPENDIX

Not Applicable

### BACKGROUND OF THE INVENTION

This invention is intended to ease the difficult task of lacing footwear and subsequent bow tying. Young children and mentally challenged persons commonly experience failure when attempting shoe lacing and bow tying. The challenge of parents and teachers to successfully educate their children or students often ends unsuccessfully in frustration.

It is often a challenge when trying to instruct children, attention and focus are readily lost when success seems out of reach. This device is designed to grab the attention of the child by using bright primary colors coupled with simple visual and verbal instruction. By allowing a child to split the complex tasks into two distinct goals—1) lacing 2) bow tying, success is better achieved. Children often get frustrated when instructions are complex and goals are out of reach. The prospect of failure often results in frustration and resignation. Extended attention is better achieved by simplifying goals. Simply completing the task of shoe lacing will naturally extend the child's interest and willingness to continue. Competitive interest is generated when success is realistically contemplated.

It is the object of this invention to offer an educational device to teach a child to lace shoes and bow tie the shoestring.

It is also the object of this invention to grab the attention of the child by offering a simple visually interesting device.

### BRIEF SUMMARY OF THE INVENTION

An educational device for teaching, training, and aiding a child or mentally challenged person to lace shoes and tie a shoelace bow is of simple construction and provides easy guidance. The shoe device is composed of a symmetrical flat base approximating the shape of a shoe with two flat panels containing equally spaced holes attached oppositely on the outer edge of the flat base so as to resemble a pair of opposing flaps. Each component is colored using differing primary and secondary colors to focus attention and aid in separating regions of the device for ease of instruction.

In designing the device, I chose to offer a simple shape approximating the outline of a shoe with contrasting panels attached thereto. Each panel has an equal number of holes equally spaced along the length. The length of provided shoestring is split equally by two distinct colors, which simplifies and facilitates communication of shoe lacing and bow tying instructions.

### BRIEF DESCRIPTION OF THE SEVERAL VIEWS OF THE DRAWINGS

Referring to the drawings, numeral 1 represents an educational device for teaching a young child to tie a shoelace bow. Educational device 1 is in the form of an outline of a shoe with contrasting panels. The educational device 1 is formed by a piece of plastic 16 covered by sections 13,12, 10, 14, 6 with colored denier, on which is mounted a pair of panel flaps 6 which simulate the side flaps of a laced-up shoe.

The educational device 1 is outlined with cotton binding 2 sewn to the device by thread 3. The educational device 1 is provided with eight lacing eyelets 8 located in two rows of each four eyelets 8, which extend along both panel flaps 6. The shoelace 15 provided with the educational device is 45 inches in length and is a standard adult size shoestring. The shoelace 15 threads through the eyelets 8 located on panel flaps 6, is removable and can therefore be used to aid in teaching a young child to lace as well as to tie a shoelace bow. Since the shoelace 15 is held only by threading through eyelets 8, it is possible for a parent to replace the shoelace 15 with a standard white shoelace as shoe lacing and bow tying become common practice for the child or mentally challenged person.

### DESCRIPTION OF PREFERRED EMBODIMENT

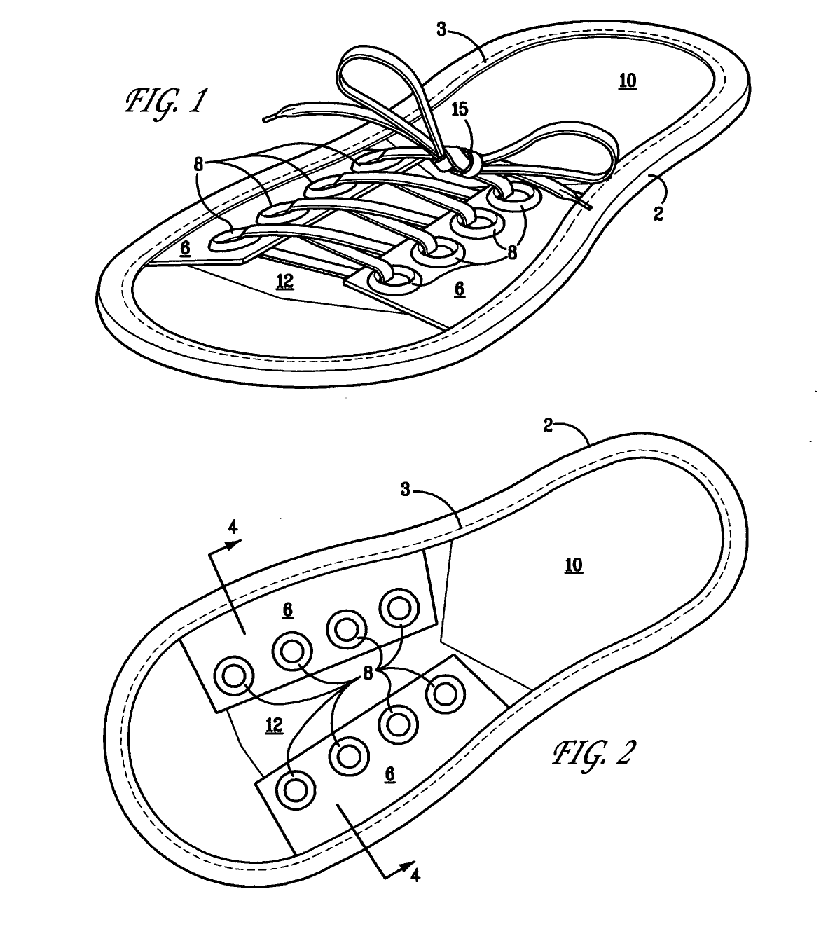

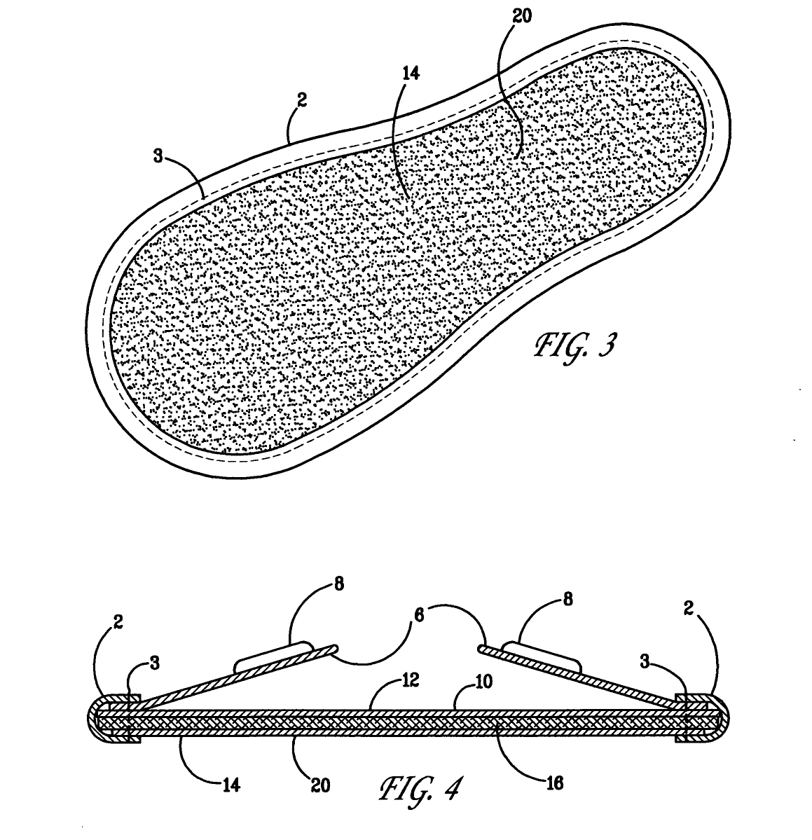

A first embodiment, an apparatus for teaching children how to tie shoe laces generally identified by reference numeral 1, will now be described with reference to FIGS. 1 through 3. Referring to FIG. 1 apparatus shown in an assembled state, is in the form of an enlarged shoe. FIG. 1 sets forth a perspective view of an educational device constructed in accordance with the present invention and generally referenced by numeral 1. FIG. 2 is a top perspective view of the educational device shown without the shoelace 15. In an assembled state, FIG. 3 is a bottom perspective view of the educational device constructed in accordance with the present invention and generally referenced by numeral 14. FIG. 4 is a frontal perspective cross section view of the educational device. Referring now in detail to the drawings. FIG. 1 illustrates a shoe-like educational device which may be formed of any type of material commonly employed in sport shoe construction such as, for example, nylon, 600 denier or the like. FIG. 1 has several parts that are conjoined together by thread (sewn) 3.

In the illustrated educational device 1 the shoe has a fabric binding 2 which fastens the top portion to the bottom portion 20. The toe part or front section 13 is fastened to the mid section 12 which is fastened to the heel section 10. These three sections are sewn together and are made from color contrasting 600 denier or like fabric. On the top of the three sections 13, 12, 10 are two opposing flaps 6 with contrasting colors fastened (sewn) to sections 13, and 12. Nylon thread 3 is used to bind the entire educational device 1 together. Punched through section 6 using a grommet machine are four equally spaced metal grommets 8 that simulate eyelets on an actual shoe. There are four equally spaced grommets 8 on opposing sides of a panel flap 6. The eyelets 8 are ⅝ of an inch in circumference, brass metallic in color, 1/16 of an inch in thickness, and are evenly spaced ⅜ of an inch apart. The educational device 1 has the appearance of an actual shoe, except that it is larger than the child's actual shoe and flat. The educational device 1 is 11¾ of an inch in length from section 13 to section 10 and 5 1/16 at the widest or toe area 13. The educational device 1 tapers down to 3¾ of an inch in the heel section 10. The opposing flaps 6 are 4½ inches in length and doubled over to create a sense of sturdiness. The width of the flaps 6 are 1⅝ of an inch and tapers to 1⅜ of an inch. The flap 6 is fastened (sewn) to sections 13 and section 12.

The cotton binding 2 is sewn 3 around the outer edge of the educational device 1 to bind and contain the internal plastic section 16 that makes the educational device 1 flexible. FIG. 3 is the bottom or underside view of the educational device 1. The sole 14 is made out of a thin rubbery anti slip substrate called margel. This specific substrate will aid in the maintaining of placement on household furniture as well as school tables and desks with smooth surfaces where individuals learn how to tie their shoes. The sole has a texture 20 of little bumps, crevices and ridges which aid in keeping placement.

1. (canceled)

2. An educational device for teaching children and learning disabled persons to tie shoe laces, comprising: a simulated shoe, including a sole portion; a toe portion; an upper portion having several pairs of eyelets whereby a shoe is laced onto the upper portion; and wherein the sole portion, and upper portion being conjoined as a single piece of flexible material.

3. The educational device defined in claim 2 including the use of primary and secondary colors on all parts of the educational device.

4. The educational device defined in claim 2 wherein: said device is to be placed front of children and learning disabled persons and not to be worn as a shoe.
